(19) United States
(12) Patent Application Publication
(10) Pub. No.: US 2018/0350404 A1
(43) Pub. Date: Dec. 6, 2018

(54) VIDEO SPLITTER

(71) Applicant: Microsoft Technology Licensing, LLC, Redmond, WA (US)

(72) Inventor: Arnaud Zirnheld, Limhamn (SE)

(21) Appl. No.: 15/611,767

(22) Filed: Jun. 1, 2017

(51) Int. Cl. G11B 27/00; G11B 27/031; G11B 27/34; H04N 5/268; H04N 5/262

(52) U.S. Cl. CPC G11B 27/007; G11B 27/031; H04N 5/2628; H04N 5/268; G11B 27/34

(57) ABSTRACT

A video splitting apparatus is described which has a processor configured to receive a source video and to compute a plurality of portions of the source video. The video splitting apparatus has at least one video frame player configured to render video frames at a display associated with the video splitting apparatus. The processor is arranged to play the plurality of portions together as first individual loops using the at least one video frame player. The processor is configured to receive user input selecting one of the portions and specifying navigation through the selected portion.

### BACKGROUND

Video players are available which receive encoded video, decode the video and play the video on a display associated with the computing device which is executing the video player. Such video players are widely available on a variety of computing devices including but not limited to: smart phones, tablet computers, game consoles, desktop computers and others. These types of video players typically provide functionality to control how the video is played such as controls to start, pause, stop, forward and reverse the play of the video.

The embodiments described below are not limited to implementations which solve any or all of the disadvantages of known video players.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A video splitting apparatus is described which has a processor configured to receive a source video and to compute a plurality of portions of the source video. The video splitting apparatus has at least one video frame player configured to render video frames at a display associated with the video splitting apparatus. The processor is arranged to play the plurality of portions together as first individual loops using the at least one video frame player. The processor is configured to receive user input selecting one of the portions and specifying navigation through the selected portion.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a video splitter accessible to a client computer over a communications network;

FIG. 1A is a schematic diagram of a splitter configured to form a plurality of portions of a source video;

FIG. 1B is a schematic diagram of a splitter configured to compute time codes and/or key frames used by a frame accessor to select frames from a source video to be played;

FIG. 1C is a schematic diagram of a user interface display of a video splitter;

FIG. 1D is a schematic diagram of another user interface display of a video splitter;

FIG. 2 is a flow diagram of a method of operation at a video splitter;

FIG. 3 is a flow diagram of a method of forming an edit list and computing a video from the edit list;

FIG. 4 is a flow diagram of a method of computing audio time codes;

FIG. 5 illustrates an exemplary computing-based device in which embodiments of a video splitter are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example are constructed or utilized. The description sets forth the functions of the example and the sequence of operations for constructing and operating the example. However, the same or equivalent functions and sequences may be accomplished by different examples.

Video is typically encoded using a standard format (such as MPEG-4 as defined by the International Organization for Standardization, or other standard format) and is played using a video player configured for the particular video format to be used. A computing device receives the video in encoded form which is significantly reduced in size as compared with the original, un-encoded video. The video player decodes the video according to the particular standard being used, and renders the decoded video at a display screen associated with the computing device.

Video compression using such encoding schemes is particularly useful since the size of a source, un-encoded video is significant. A video player configured to play several tens of frames per second, for a video which is several hours long, comprises a very large number of frames of data.

Where a user desires to view a lengthy video he or she has the option to use a fast forward facility whereby a frame rate of the video player is increased. The number of frames per second is greater than the frame rate which the author of the video intended. As the frame rate increases it becomes increasingly difficult for the end user to perceive the objects depicted in the video as the rendered content appears blurred. Thus it is difficult for the end user to understand the content of the video without playing the video at a frame rate at or close to the frame rate intended by the author and this is often very time consuming. In the case of surveillance videos there are typically many tens of hours of video footage to be viewed in order to assess the content of the video.

Automated video analysis tools are complex and expensive. Typically these automated tools are operated by experts and are trained in advance using training videos tailored for specific application domains such as surveillance.

In various examples described herein there is a video splitter which forms portions of a video into loops and plays the loops together so that an end user is able to view the loops at the same time. In this way the end user is able to view the video in a fraction of the time taken to view the complete video, and using a frame rate similar to that intended by an author of the video. In various examples, a user is able to search the video content by controlling the selection of the portions and this provides a fast, effective and intuitive way of finding content in a video. In various examples, a user is able to mark frames of the video and create a new video on the basis of the marked frames.

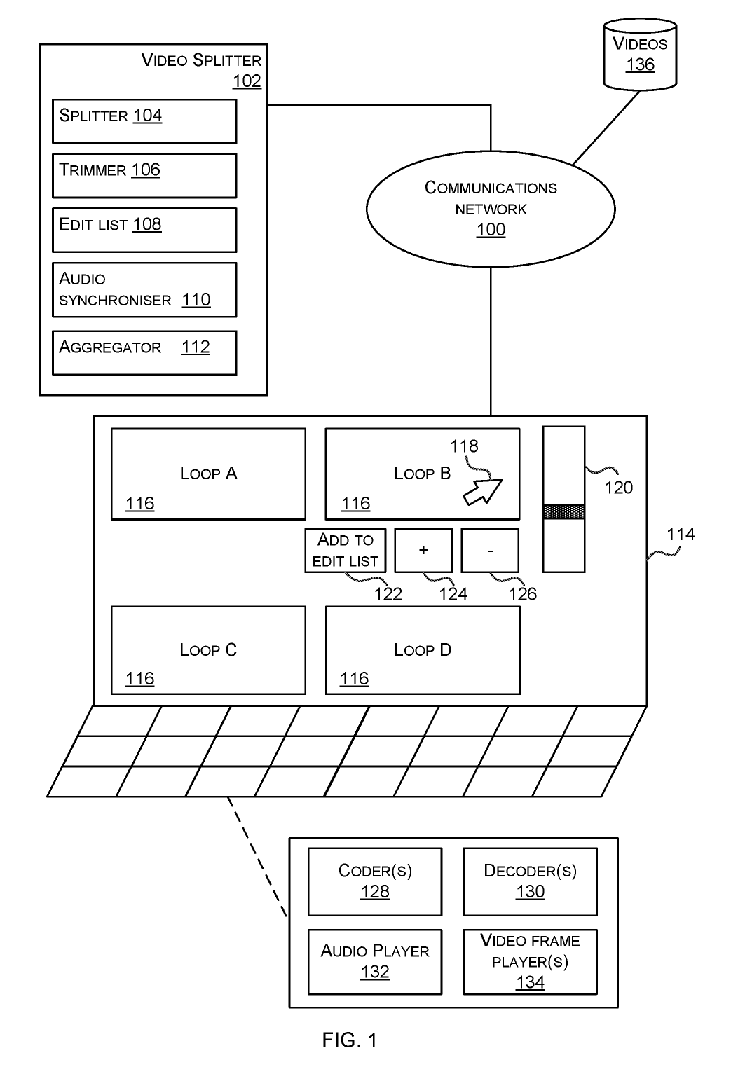

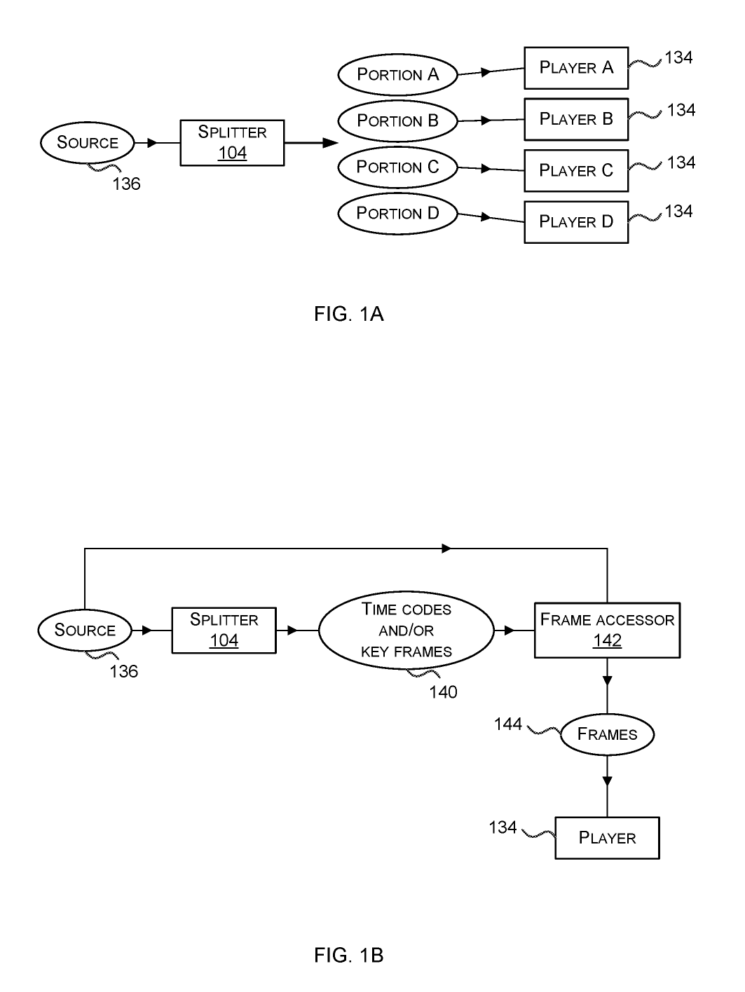

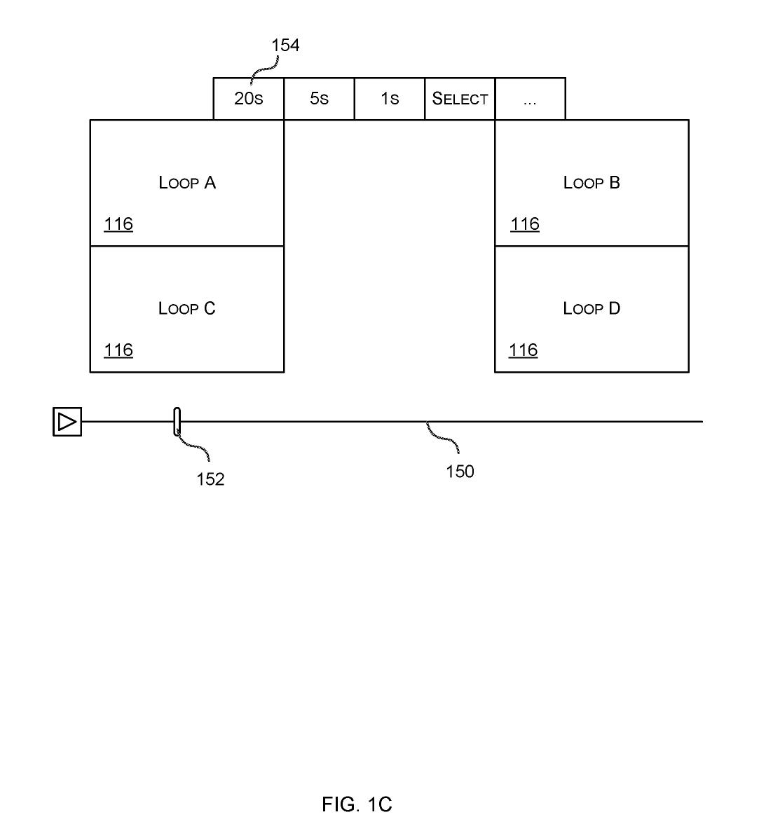

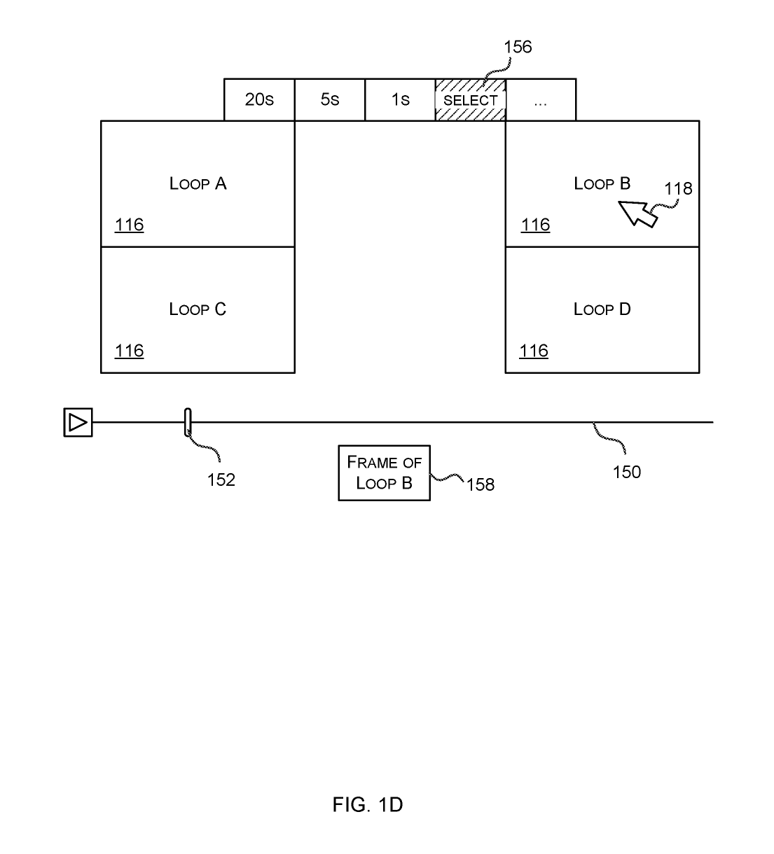

FIG. 1 is a schematic diagram of a computing device 114 which in this case is a laptop computer. However, any type of computing device 114 may be used and a non-exhaustive list of examples of computing device 114 is: smart phone, tablet computer, augmented reality computing device, electronic white board, desktop computer.

The computing device 114 comprises one or more coders 128 such as video encoders, audio encoders, and the computing device comprises one or more decoders 130 such as video decoders and audio decoders. The computing device 114 comprises an audio player 132 and one or more video players 134 as described in more detail below.

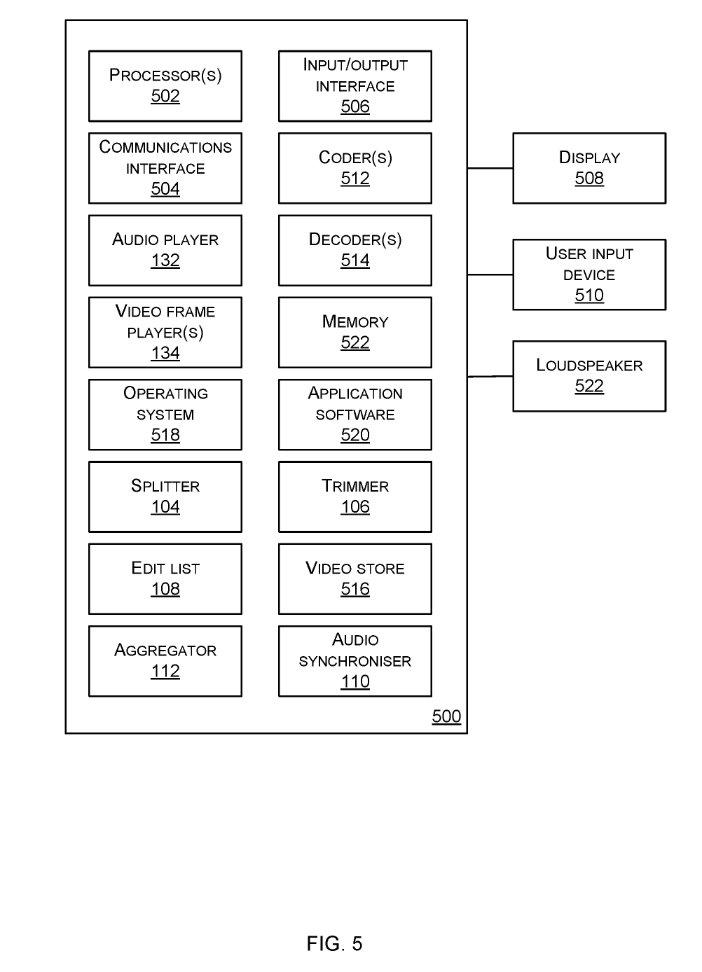

The computing device in FIG. 1 is in communication with a video splitter 102 via a communications network 100 such as the internet, an intranet or any other communications network. The video splitter 102 comprises a splitter 104, a trimmer 106, an edit list 108, an audio synchronizer 110 and an aggregator 112. Other components of the video splitter 102 are described later with reference to FIG. 5. The video splitter 102 and the computing device 114 have access to one or more videos such as from video store 136 or videos stored at other locations, including at the computing device 114 and the video splitter 102.

Although the video splitter 102 is shown in FIG. 1 as being located at a computing entity remote of the computing device 114 this is not essential. The functionality of the video splitter 102 is at the computing device 114 in some examples. The functionality of the video splitter is distributed between the computing device 114 and one or more other computing devices in some cases.

The splitter 104 receives a source video such as from store 136 or another location, and computes a plurality of portions of the source video, such as by dividing the source video or in other ways as described below. The video frame player(s) 134 at the computing device 114 play the portions of the source video as loops, so that the loops are played together. In the example of FIG. 1 a source video has been divided into four portions which are played as loop A, loop B, loop C and loop D in proximate regions 116 of the display. The loops are played together; that is while one loop is playing the other loops are also playing. In this way a user is able to view the playing loops together and so reduce the amount of time taken to view the content of each loop as compared with viewing each loop separately. Although four loops are shown in FIG. 1 other numbers of loops are possible. The audio associated with the source video is either switched off, or is played in respect of only one of the loops.

In the example of FIG. 1 each loop is displayed at the same display which is a display screen of a laptop computer. However, this is not essential as in some cases one or more of the loops is displayed at another display associated with the computing device 114 such as where the laptop computer 114 is paired with a smart phone of the user.

In the example of FIG. 1 a cursor 118 has been used to select loop B and user selectable control elements 122, 124, 126, 120 have been generated by the computing device 114 and/or video splitter 102. The user selectable control elements include an add to edit list button 122 which is used to mark individual frames of the loop, a zoom in button 124 which is used to form new loops by navigating towards the leaves of an n-tree representation of the source video, a zoom out button 126 which is used to form new loops by navigating towards the root of an n-tree representation of the source video, and a time line slider 120 which is used to control a location in a video and/or audio signal of the source video, where the location corresponds to a current frame of loop B. Play and pause buttons are also available but are not illustrated in FIG. 1 for clarity. The add to edit list button 122 is used to add a time code of a current frame to an edit list as described in more detail later. In some examples the buttons for zooming 124, 126 appear over the regions 116 and are hidden until the cursor 118 is in the region.

In various examples, a user is able to operate a zoom in function and a zoom out function to identify a moment in a video where a moment is one or more frames of a video, a photo, or an animated photo. When the moment is identified it is added to an edit list. This is described in more detail with reference to FIG. 3 later in this document.

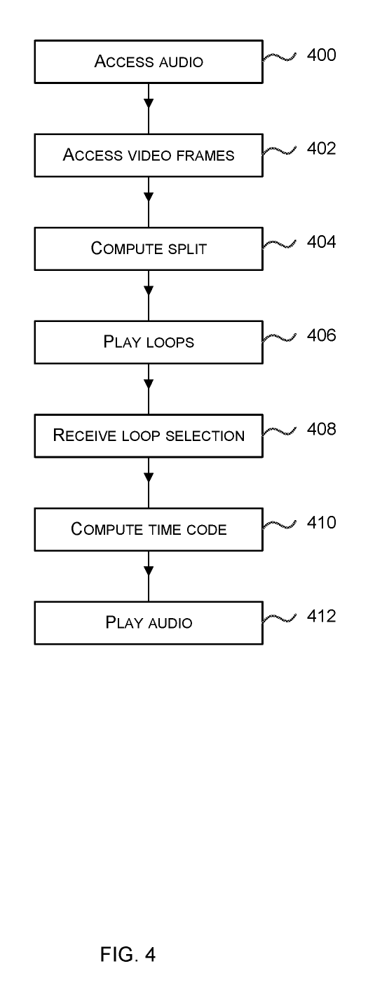

In various examples the user can play portions of a video in a multi-display-region interface as illustrated in FIG. 1 where there is a plurality of regions 116. In some cases audio is played from an audio file of the source video so that the audio is synchronized with respect to one of the loops as explained in more detail with reference to FIG. 4 later in this document.

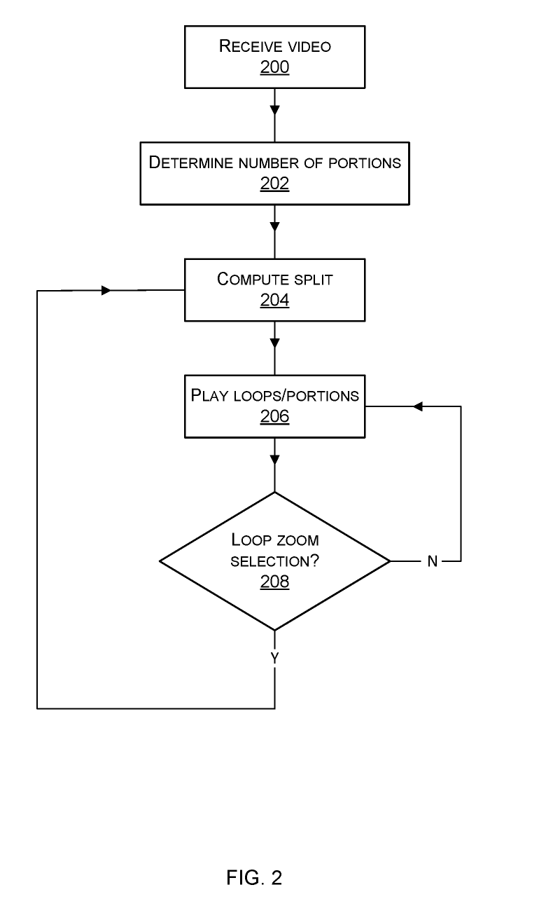

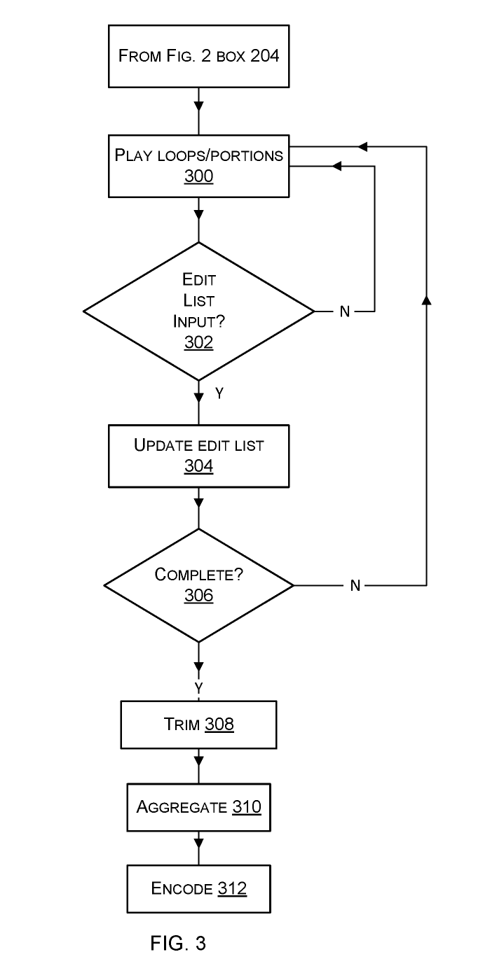

By using the zoom in and zoom out functions it is possible to quickly find a desired sub-sequence of a video (such as a chapter on a digital versatile disk) without needing to make a large number of user input actions and this reduces burden of user input from the point of view of the end user. FIG. 2 and the associated description relate to use of the zoom in and zoom out functions which enable an n-tree navigation of the source video. An n-tree is a graphical structure in the form of a tree with n branches from the root node and each internal node of the tree. The root node represents the source video and each internal node represents a portion of the source video formed by sub-dividing the source video according to the position of the internal node in the tree.

Alternatively, or in addition, the functionality of the video splitter 102 described herein is performed, at least in part, by one or more hardware logic components. For example, and without limitation, illustrative types of hardware logic components that are optionally used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

FIG. 1A illustrates the situation where the computing device 114 has a plurality of video frame players 134. In this case a source video 136 is processed by the splitter 104 to form a plurality of portions where each portion comprises a plurality of frames of the source video 136. In the example of FIG. 1A there are four portions A-D but this is not essential as long as there are two or more portions. The computing device 114 has a plurality of video frame players 134 such that an individual portion of the source video is played by an individual video frame player 134. Each video frame portion may be played by a different video frame player 134. This is a simple and effective way of splitting the source video into portions and playing those portions. The particular format of the video does not need to be taken into account. In some cases, each portion is formed into a loop which is played by the respective player. Since loops are played, any drift between the individual players 134 does not matter and it is not necessary to synchronize the individual players 134. In addition, navigation in an n-tree representation of the source video is not influenced by drift between the players.

The scenario of FIG. 1A is also applicable where the video portions are defined logically by ranges of frames, or by a starting frame or time code and a length (number of frames in the portion).

FIG. 1B illustrates the situation where a single video frame player 134 is used. By using only one video frame player 134 costs are reduced as compared with the situation of FIG. 1A. Since only one video frame player 134 is used there is no problem of drift between separate video frame players 134.

A source video 136 is received and the splitter 104 computes a plurality of time codes and/or key frames of the source video 136 which specify portions of the source video 136. In the case of MPEG-4, key frames are computed where a key frame is a frame of a video which has been marked by the encoder and where some but not all frames of the video are key frames. In the case of MJPEG, time codes are computed which specify any individual frame of an MJPEG video. Time codes and/or key frames are computed for other formats of video. A portion of the video may be specified using at least one time code and/or key frame. In some cases the time codes and/or key frames are computed by a video analyzer which analyses the source video to identify scenes of interest.

The time codes and/or key frames are passed to a frame accessor 142 which retrieves frames 144 of the source video 136, according to the times codes and/or key frames and passes those to the player 134. The player knows the number of portions of the source video and it plays the retrieved frames 144 at appropriate ones of regions of the display so that the loops are played. In some cases the player knows the number of portions of the source video by receiving this information from the splitter 104, or by using a default number of portions configured in manufacturing or by user settings.

FIG. 1C is a schematic diagram of a user interface display of a video splitter 102. The user interface display has a plurality of separate regions 116 each region being for displaying a video loop computed by the video splitter from a source video. In this example there are four regions 116 but other numbers of regions may be used. A single video timeline 150 is rendered together with the regions 116 and comprises a slider element 152 which is movable by a user to control the video loops played in the regions 116 by effecting the same action on each of the video loops being played in the regions 116. The user interface display also comprises selectable duration elements 154 to select a duration of the individual video loops displayed in the individual regions 116. In the example indicated there are three selectable duration elements 154 for the durations 20 seconds, 5 seconds and 1 second. When the selectable duration element is selected for the duration 20 seconds, each of the individual loops A to D comprises a portion of a source video, where the portion has a duration of 20 seconds. The selectable duration element controls the length of the portion of the source video used to form each loop of the individual regions 116. The length of the video timeline 150 represents the length of one of the portions, such as 20 seconds. The position of the slider element 152 on the video timeline 150 represents the time of a current frame displayed in a region 116 with respect to a start of the respective portion of the source video. Operation of the selectable duration elements 154 is constrained by navigation in the n-tree representation of the source video. For example, when the twenty second duration is selected, the user is able to navigate towards the leaves of the tree by selecting one of the regions 116, but the user is unable to select the 5 second duration element whilst the twenty second duration element is already selected. If the video portions in the regions 116 are of 5 seconds or less, the use is able to select the twenty second duration element in order to navigate towards the root of the n-tree representation of the source video.

In the case where a user is searching for a particular frame in a source video the user begins by selecting a selectable duration element with a longest duration. The video splitter splits the source video into portions as described in more detail below and each portion is played as a loop in one of the regions 116. The user selects one of the regions which contains the frame he or she is looking for. The video splitter splits the portion of the source video which is currently displayed in the selected region into four further portions. The four further portions are displayed as loops in the regions 116. The user repeats this process until he or she is easily able to identify the desired frame. The user selects the selectable element 156 which is marked “select” as indicated in FIG. 1D. The user operates a cursor 118 to select the desired frame which in this example is a frame of loop B. The desired frame 158 is added to an edit list and displayed near the video timeline. The user is able to add more frames to the edit list by repeating the process described.

In the examples of FIGS. 1C and 1D a second video timeline is used in some cases. This second video timeline indicates the duration of the current portions being played in the regions 116 with respect to the whole source video.

FIG. 2 is a flow diagram of a method at a video splitter 102. The video splitter receives 200 a source video such as by receiving an address of a source video or a pointer to a source video. A splitter 104 determines 202 a number of portions of the source video to be computed. The number of portions is preconfigured in some cases during a manufacturing stage, or by using settings. In some cases the number of portions is determined according to user input such as a voice command, or other modality of user input specifying a number of portions to be computed. In some cases the number of portions is determined according to a number of video frame players available at a computing device.

The splitter 104 computes 204 the portions by dividing the source video into the determined number of portions. In some cases the portions comprise substantially the same number of frames but this is not essential. The division of the source video into the determined number of portions is a logical division in some cases so that each portion is defined by a starting time code or frame and a length (where the length is a number of frames), or by a starting time code or frame and an end time code or frame. The division of the source video is a physical division in some cases whereby the output is a plurality of video portions each comprising a plurality of frames as illustrated in FIG. 1A.

The splitter 104 makes its output available to one or more video frame player(s) 134 at a computing device such as the laptop computer 114 of FIG. 1. The video player(s) 134 play 206 a plurality of video loops, one video loop per portion. Audio is switched off, or is played for only one of the playing video loops. The video loops are rendered at one or more displays associated with the computing device 114 and played substantially at the same time. This enables a viewer to observe the individual video loops together and save time as compared with viewing each portion of the source video in series.

In some embodiments, the video frame player(s) are configured such that, if a user pauses, stops, reverses, or forwards one of the loops, this action is applied to each of the loops. Where a plurality of video frame players are used, communications between the individual video frame players are used to enable the actions to be applied to each of the loops.

In some embodiments, the video frame player(s) are configured such that if a user pauses, stops, reverses or forwards one of the loops, this action is applied independently for the particular loop concerned.

FIG. 2 illustrates the ability of the video splitter to facilitate searching a video. Once the loops are playing at operation 206 the video splitter checks for a loop zoom selection at check 208. A loop zoom selection is user input indicating to zoom in, or zoom out of the video loops. If a loop zoom selection is detected at check 208 the video splitter computes the portions again at operation 204 and proceeds to play 206 the recomputed loops. If the loop zoom selection is not detected at check 208 the video frame player(s) continue to play 206 the loops.

In the case that the loop zoom selection indicates to zoom in, the splitter 104 receives an indication of which one of the playing loops (referred to as first individual loops) is currently in focus. The currently in focus playing loop is the loop that a user has selected. The splitter 104 computes the portions at operation 204 by computing portions of the currently in focus portion. The updated portions are played as loops and replace the previously playing loops. When the user input selecting one of the portions comprises an indication to zoom into the portion a processor of the computing device is configured to split the selected portion into further portions and play the further portions as loops replacing the first individual loops.

The zoom in operation is repeated if another zoom in selection is received and in this way a user is able to drill down into a portion of the source video to locate a particular frame or group of frames. In the case that the number of portions is four and is the same for each zoom in operation, the result is a quad-tree search of the video. In the case that the number of portions is two and is the same for each zoom in operation, the result is a binary tree search of the video. The zoom-in operation is thus an n-tree search of the video where n is the number of portions and n is the same for each zoom in operation.

In the case that the loop zoom selection indicates to zoom out, the splitter computes the portions at operation 204 by computing portions of the source video, where one of the portions comprises the portions of the currently playing loops. The zoom out operation is repeated if another zoom out selection is received and in this way a user is able to move back from a particular frame or group of frames to a larger range of frames of the source video. When the user input selecting one of the portions comprises an indication to zoom out of the portion, a processor of the computing device is configured to combine the portions and replace the first individual loops by at least the combined portions.

During the zoom in operation some of the portions are cached and reused during the zoom out operation.

In some cases where an n-tree search is used, an n-tree representation of the source video is computed in advance and stored in memory. In some cases the leaves of the n-tree representation are mapped to specified time codes of the source video. The time codes are specified by a user, or are computed by an automated analyzer or are determined using a hybrid of user input and automated analysis. An automated analyzer assesses the content of the source video and detects scene changes or frames of interest. Internal nodes of the n-tree representation of the source video are also associated with time codes in some cases.

During the method of FIG. 2 it is not essential to use any audio, however, audio is available to be played using the audio player.

The video splitter 102 has an edit list 108 and a trimmer 106. The edit list is a store holding a list of marked frames of the source video which may also be referred to as moments that a user is desiring to mark and return to later. Thus the edit list stores single time codes, one for each marked frame. Optionally associated with each single time code in the edit list is a level in the n-tree representation of the source video which is a level comprising a portion of the source video from which the user selected the frame with the time code during construction of the edit list. The marked frames are computed from user input, optionally using trimmer 106, as described with reference to FIG. 3. The trimmer 106 is functionality to enable a user to have fine grained control over which frame(s) of one of the loops are rendered, as compared with coarser grained control given by the n-tree search mentioned above. The trimmer is preferably operated via a separate user interface to that of the main video splitter.

The video splitter 102 has received a source video 200, determined 202 a number of portions, computed 204 the portions and is playing loops 206. Audio is optionally played for one of the loops. At this stage the video splitter is at operation 300 of FIG. 3. The video splitter 102 checks at check 302 for edit list input received from a user. The edit list input is given by a voice command, or by selection of an add to edit list button 122 or in any other way. The edit list input specifies a frame of the source video such as a current frame of one of the playing loops. If edit list input is received the video splitter updates 304 the edit list by adding an identifier of the frame associated with the edit list input. If edit list input is not received the video splitter returns to operation 300.

The video splitter, after update 304 of the edit list, checks whether the edit list is complete 306. In some cases this is done when a threshold number of edit list entries has been made. In some cases this is done when a user specifies that the edit list is complete. If the edit list is not complete the process returns to operation 300.

If the edit list is complete an optional trim operation 308 is done using trimmer 106. In the trim operation 308 the user is able to refine the edit list by using a jog shuttle or video timeline slider. A jog shuttle is a gear shaped graphical user interface icon which is rotatable. A user is able to rotate the jog shuttle in a clockwise or an anticlockwise direction and is able to control the amount of rotation of the jog shuttle. The direction of rotation is used by the trimmer to control a direction of play of at least one of the video loops. The amount of rotation is used by the trimmer to control a frame rate of play of at least one of the video loops. A jog shuttle is operable to select a single specific frame of a video. A video timeline slider is a graphical user interface element comprising a line which represents time taken to play a video, and whereby a user is able to slide a slider along the line in order to move to a particular frame of the video.

If the user selects to enter the trim operation 308, by making user input such as a voice command or selection of a user interface element, the trimmer 106 instructs the video frame player(s) 134 to play the video loops and to indicate graphically which frames of the video loops have been marked as being in the edit list. A user is able to pause a video loop at or close to a frame which has been marked as being in the edit list. The user is then able to use the jog shuttle or a video timeline slider to scroll through individual frames of the video loop around the marked frame. If the user finds a frame which is a better frame, in his or her opinion, to be included in the edit list, the user operates the add to edit list button 122 to mark the frame which has been found and replace the corresponding edit list entry. In this way a user is able to refine the edit list using the trimmer 106.

The video splitter creates a new video from selected frames of the source video in an aggregation operation 310. The aggregation operation comprises selecting frames of the source video which have entries in the edit list, or are between two entries in the edit list. In an example, the aggregation operation 310 comprises selecting one or more ranges of frames in the source video. A range is selected by starting from a source video frame corresponding to a first edit list entry and selecting all the frames of the source video until a frame corresponding to the immediately subsequent edit list entry is reached. Once the frames are selected from the source video using the edit list these are aggregated 310 into a single video by relabeling the frames so the frame numbers are consecutive. The resulting single video is then encoded 312. The encoded video is stored or transmitted to another entity. To create an audio signal for the created video, an audio signal of the source video is used. Parts of the audio signal are extracted from the audio signal of the source video according to time codes of the selected frames of the video. The extracted audio signal parts are joined together to form an audio signal for the newly created video. The audio signal for the newly created video is smoothed in order to mitigate against abrupt changes in the audio signal at locations in the signal where audio signal parts are joined.

In the examples described above with reference to FIGS. 2 and 3, video loops are played. In this way portions of different lengths are possible whilst the video frame player(s) are able to continuously play content. However, the methods of FIGS. 2 and 3 are applicable to portions which are played linearly and not as a loop.

FIG. 4 is a flow diagram of a method of audio synchronization implemented at audio synchronizer 110. An audio signal of the source video is accessed 400. Suppose for the sake of example that the source video depicts a famous guitarist playing a guitar solo and the audio signal is a recording of the guitar solo. The video splitter accesses 402 the source video frames and computes 404 portions of the source video. Suppose that 30 portions are computed. The video frame player(s) play 406 a plurality of video loops, one for each video portion which was computed. In this example, thirty video loops are rendered at a display associated with the computing device such as the laptop computer of FIG. 1.

A user views the video loops and is trying to learn how to play the guitar solo, even though the user is not able to read sheet music. The video splitter receives 408 user input selecting one of the video loops which depicts the next finger positions that the user wishes to learn. The use is still able to see all the video loops and so is able to understand where in the guitar solo the selected video loop is. The user would like to hear the audio associated with the selected video loop. The audio synchronizer identifies the frame numbers or frame identifiers of the frames of the selected video loop, and it computes 410 an associated time code for at least two of the frames of the selected video loop (an earliest frame and a latest frame of the video loop). The audio synchronizer retrieves from the source audio signal the part of that signal identified by the associated time codes. The audio synchronizer instructs 412 the audio player 132 to play the retrieved part of the audio signal.

FIG. 5 illustrates various components of an exemplary computing-based device 500 which are implemented as any form of a computing and/or electronic device, and in which embodiments of a video splitter are implemented in some examples.

Computing-based device 500 comprises one or more processors 502 which are microprocessors, controllers or any other suitable type of processors for processing computer executable instructions to control the operation of the device in order to split a video into portions and play the portions together as loops. In some examples, for example where a system on a chip architecture is used, the processors 502 include one or more fixed function blocks (also referred to as accelerators) which implement a part of the method of FIGS. 2 to 4 in hardware (rather than software or firmware). Platform software comprising an operating system 518 or any other suitable platform software is provided at the computing-based device to enable application software 520 to be executed on the device. The application software includes an audio player 132 and one or more video frame players. The computing-based device 500 comprises one or more coders 512 to encode video and/or audio signals. The computing-based device 500 comprises one or more decoders to decode encoded video and/or audio signals. The computing-based device 500 comprises a splitter 104, trimmer 106, video store 516, edit list 108, aggregator 112 and audio synchronizer 110 which implement the functionality described earlier in this document.

The computer executable instructions are provided using any computer-readable media that is accessible by computing based device 500. Computer-readable media includes, for example, computer storage media such as memory 522 and communications media. Computer storage media, such as memory 522, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 522) is shown within the computing-based device 500 it will be appreciated that the storage is, in some examples, distributed or located remotely and accessed via a network or other communication link (e.g. using communication interface 504).

The computing-based device 500 also comprises an input/output controller 506 arranged to output display information to a display device 508 which may be separate from or integral to the computing-based device 900. The display information may provide a graphical user interface. The input/output controller 506 is also arranged to receive and process input from one or more devices, such as a user input device 510 (e.g. a touch panel sensor, stylus, mouse, keyboard, camera, microphone or other sensor). In some examples the user input device 510 detects voice input, user gestures or other user actions and provides a natural user interface (NUI). This user input may be used to specify a source video, select a video loop, specify a number of video loops, operate an edit list button, operate a zoom in button, operate a zoom out button and for other purposes. In an embodiment the display device 508 also acts as the user input device 510 if it is a touch sensitive display device. The input/output controller 506 outputs data to devices other than the display device in some examples, e.g. a locally connected printing device.

Any of the input/output controller 506, display device 508 and the user input device 510 may comprise natural user interface (NUI) technology which enables a user to interact with the computing-based device in a natural manner, free from artificial constraints imposed by input devices such as mice, keyboards, remote controls and the like. Examples of NUI technology that are provided in some examples include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that are used in some examples include intention and goal understanding systems, motion gesture detection systems using depth cameras (such as stereoscopic camera systems, infrared camera systems, red green blue (rgb) camera systems and combinations of these), motion gesture detection using accelerometers/gyroscopes, facial recognition, three dimensional (3D) displays, head, eye and gaze tracking, immersive augmented reality and virtual reality systems and technologies for sensing brain activity using electric field sensing electrodes (electro encephalogram (EEG) and related methods).

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

This acknowledges that software is a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

Alternatively or in addition to the other examples described herein, examples include any combination of the following:

A video splitting apparatus comprising:

a processor configured to receive a source video and to compute a plurality of portions of the source video;

at least one video frame player configured to render video frames at a display associated with the video splitting apparatus;

wherein the processor is arranged to play the plurality of portions together as first individual loops using the at least one video frame player; and

wherein the processor is configured to receive user input selecting one of the portions and specifying navigation through the selected portion.

The video splitting apparatus described above wherein the processor plays the plurality of portions in proximity to one another on the display.

The video splitting apparatus described above wherein the processor plays the plurality of portions at the same time.

The video splitting apparatus described above wherein the processor plays an audio signal associated with only the selected portion.

The video splitting apparatus described above wherein the processor computes the plurality of portions by dividing the source video into subsequences comprising either logically defined subsequences or comprising subsequences of video frames.

The video splitting apparatus described above comprising a plurality of video frame players with at least one video frame player for each portion.

The video splitting apparatus described above wherein the user input selecting one of the portions comprises an indication to zoom into the portion and wherein the processor is configured to split the selected portion into further portions and play the further portions as loops replacing the first individual loops.

The video splitting apparatus described above wherein the user input selecting one of the portions comprises an indication to zoom out of the portion and wherein the processor is configured to combine the portions and replace the first individual loops by at least the combined portions.

The video splitting apparatus described above wherein the processor is configured to receive user input selecting a frame of the selected portion and to stored an identifier of the selected frame in an edit list.

The video splitting apparatus described above wherein the processor is configured to receive user input at a jog shuttle or video timeline slider, to refine data in the edit list.

The video splitting apparatus described above wherein the processor is configured to receive user input selecting starting frames and ending frames of ranges of frames and to store the identifiers of the starting frames and ending frames in the edit list.

The video splitting apparatus described above comprising an aggregator configured to select frames of the source video according to the edit list and to aggregate the selected frames to form a new video.

The video splitting apparatus described above wherein the aggregator encodes the selected frames as a single video.

The video splitting apparatus described above comprising an audio synchronizer which computes a time code of an audio signal of the source video which corresponds to the selected portion.

A computer-implemented method comprising:

at a processor, receiving a source video and computing a plurality of portions of the source video;

using at least one video frame player, playing the plurality of portions together;

receiving user input selecting one of the portions and specifying navigation through the selected portion; and

updating the playing of the selected portion according to the received user input.

The method described above wherein the updating of the playing of the selected portion is independent of the playing of the other portions.

The method described above comprising using a plurality of video frame players, one for each portion.

The method described above comprising determining the number of portions of the plurality of portions from one or more of: user input, pre configured data, a number of video frame players available.

The method described above comprising, when the user input selecting one of the portions comprises an indication to zoom into the portion, splitting the selected portion into further portions and playing the further portions as loops replacing the first individual loops.

A video splitting apparatus comprising:

a processor configured to receive a source video and to compute a plurality of portions of the source video;

at least one video frame player configured to render video frames at a display associated with the video splitting apparatus;

wherein the processor is arranged to play the plurality of portions together as individual loops using the at least one video frame player; and

wherein the processor is configured to receive user input marking a plurality of frames of the portions and to aggregate the marked frames to encode a single output video.

A video splitting apparatus comprising:

means for receive a source video and to compute a plurality of portions of the source video;

means for render video frames at a display associated with the video splitting apparatus;

means for playing the plurality of portions together as individual loops using the at least one video frame player; and

means for receiving user input marking a plurality of frames of the portions and to aggregate the marked frames to encode a single output video. In some examples the means for receiving a source video is the processor of FIG. 5 and the means for rendering video frames is the video frame player of the description and figures. In some examples the means for receiving user input is a user interface of a computing device and the means for aggregating the marked frames is the aggregator of the description and figures.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

1. A video splitting apparatus comprising:
a processor configured to receive a source video and to automatically compute a plurality of portions of the source video;
at least one video frame player configured to render video frames in separate regions of a display associated with the video splitting apparatus, a number of the separate regions of the display corresponding to a number of the plurality of portions of the source video;
wherein the processor is arranged to play the plurality of portions together as first individual loops using the at least one video frame player; and
wherein the processor is configured to receive user input selecting one of the portions and specifying navigation through the selected portion.

2. The video splitting apparatus of claim 1 wherein the processor plays the plurality of portions in proximity to one another on the display.

3. The video splitting apparatus of claim 1 wherein the processor plays the plurality of portions at the same time.

4. The video splitting apparatus of claim 3 wherein the processor plays an audio signal associated with only the selected portion.

5. The video splitting apparatus of claim 1 wherein the processor automatically computes the plurality of portions by dividing the source video into subsequences comprising either logically defined subsequences or comprising subsequences of video frames.

6. The video splitting apparatus of claim 1 comprising a plurality of video frame players with at least one video frame player for each portion.

7. The video splitting apparatus of claim 1 wherein the user input selecting one of the portions comprises an indication to zoom into the portion and wherein the processor is configured such that the video splitting apparatus splits the selected portion into further portions and plays the further portions as loops replacing the first individual loops.

8. The video splitting apparatus of claim 1 wherein the user input selecting one of the portions comprises an indication to zoom out of the portion and wherein the processor is configured such that the video splitting apparatus combines the portions and replaces the first individual loops by at least the combined portions.

9. The video splitting apparatus of claim 1 wherein the processor is configured to receive user input selecting a frame of the selected portion and to store an identifier of the selected frame in an edit list.

10. The video splitting apparatus of claim 9 wherein the processor is configured to receive user input at a jog shuttle or video timeline slider, to refine data in the edit list.

11. The video splitting apparatus of claim 9 wherein the processor is configured to receive user input selecting starting frames and ending frames of ranges of frames and to store the identifiers of the starting frames and ending frames in the edit list.

12. The video splitting apparatus of claim 11 comprising an aggregator configured to select frames of the source video according to the edit list and to aggregate the selected frames to form a new video.

13. The video splitting apparatus of claim 12 wherein the aggregator encodes the selected frames as a single video.

14. The video splitting apparatus of claim 1 comprising an audio synchronizer which computes a time code of an audio signal of the source video which corresponds to the selected portion.

15. A computer-implemented method comprising:
at a processor, receiving a source video and automatically computing a plurality of portions of the source video;
using at least one video frame player configured to render video frames in separate regions of a display, a number of the separate regions of the display corresponding to a number of the plurality of portions of the source video;
playing the plurality of portions together as first individual loops using the at least one video frame player;
receiving user input selecting one of the portions and specifying navigation through the selected portion; and
updating the playing of the selected portion according to the received user input.

16. The method of claim 15 wherein the updating of the playing of the selected portion is independent of the playing of the other portions.

17. The method of claim 15 comprising using a plurality of video frame players, one for each portion.

18. The method of claim 15 comprising determining the number of portions of the plurality of portions from one or more of: user input, pre configured data, a number of video frame players available.

19. The method of claim 15 comprising, when the user input selecting one of the portions comprises an indication to zoom into the portion, automatically splitting the selected portion into further portions and playing the further portions as loops.

20. A video splitting apparatus comprising:
a processor configured to receive a source video and to automatically compute a plurality of portions of the source video;
at least one video frame player configured to render video frames in separate regions of a display associated with the video splitting apparatus, a number of the separate regions of the display corresponding to a number of the plurality of portions of the source video;
wherein the processor is arranged to play the plurality of portions together as individual loops using the at least one video frame player; and
wherein the processor is configured to receive user input marking a plurality of frames of the portions and to aggregate the marked frames to encode a single output video.
